(19) United States
(12) Patent Application Publication
(10) Pub. No.: US 2013/0153409 A1
(43) Pub. Date: Jun. 20, 2013

(54) INSTALLATION FOR BREAKING AN EDGE ON A METAL PIECE

(71) Applicants: Nicolas Batista, Corbeil-Essonnes (FR); Damien Hebuterne, Breuillet (FR); Anthony Texier, Corbeil (FR)

(72) Inventors: Nicolas Batista, Corbeil-Essonnes (FR); Damien Hebuterne, Breuillet (FR); Anthony Texier, Corbeil (FR)

(73) Assignee: SNECMA, Paris (FR)

(21) Appl. No.: 13/819,796

(22) PCT Filed: Sep. 2, 2011
(86) PCT No.: PCT/FR2011/052018

§ 371 Date: Feb. 28, 2013

(30) Foreign Application Priority Data
Sep. 2, 2010 (FR) 1056981

(51) Int. Cl. B23H 9/02

(52) U.S. Cl. CPC B23H 9/02
USPC 204/242; 204/290.01

(57) ABSTRACT

An electrode for breaking an edge of a part by electrochemical machining, the electrode including at least one conductive zone configured to be arranged facing an edge of the part that is to be broken. The conductive zone is of a shape that is complementary to the shape of the broken edge to be produced and is arranged between a first portion forming an insulating extra thickness and an insulating second portion for positioning the conductive zone so that it faces the edge to be broken.

The present invention relates to an electrode and to an installation for breaking an edge on a metal part, such as a part used in aviation, for example.

Numerous industrial parts have sharp edges, e.g. a compressor or turbine rotor disk of a turbomachine that has a plurality of slots distributed around its outer circumference for mounting blade roots, with the bottoms of the slots intersecting the upstream and downstream faces of the disk at a plurality of edges. There are also edges on assembly flanges for assembling disks together, these edges being around the fastener holes and along the edges of festoons of said flanges.

Such edges often include burrs that are the consequence of making particular shapes (grooves, orifices, cutouts, . . . ) in the part. These burrs can be eliminated, for example, by mechanically breaking edges.

For this purpose, it is known to use a chamfer on the edge that is formed at the junction between two surfaces. It is also known to make a connection zone of convex section between the two surfaces. This edge breaking operation serves to avoid any risk of injury while the part is being handled and makes it possible to eliminate burrs.

At present, most edge breaking operations are performed manually by grinding, milling, brushing, or by using abrasive strips. Those operations not only take a long time, but they are also found to be difficult to perform since manual machining can lead to the machined zone receiving defects, such as scratches, for example. Furthermore, collateral damage, such as being hit with tools or localized heating, can also be observed on the part. It is thus difficult to obtain regular and uniform edge breaking over an entire edge that is to be machined. Because the edge breaking operations are performed manually and by different operators, it is impossible to guarantee good repeatability for the machining.

Another drawback lies in the testing of the broken edge. This testing step is generally performed by pressing a hardenable paste against the machined zone so as to obtain an imprint, which is subjected to lighting and then magnification by means of a magnifying glass so as to project the enlarged and inverted profile of the machined zone. Not only does that take a long time, but it is also found to be not very reliable, since the testing depends on the orientation of the lighting and on the position of the hardened imprint relative to the magnifying glass, and also on the quality with which the imprint is made.

The invention proposes a simple, effective, and inexpensive solution to all of those problems of the prior art.

To this end, the invention provides an electrode for breaking an edge of a metal part by electrochemical machining, the electrode comprising at least one conductive zone designed to be arranged facing an edge of the part that is to be broken, the electrode being characterized in that the conductive zone is of a shape that is complementary to the shape of the broken edge to be produced and is arranged between a first portion forming an insulating extra thickness and an insulating second portion for positioning the conductive zone so that it faces the edge to be broken.

The shape of the conductive zone of the electrode, which shape is complementary to the shape of the broken edge that is to be obtained, makes it possible, e.g. when the conductive zone has a particular concave curved shape, to obtain a broken edge with a corresponding convex curved shape.

The arrangement of the electrode between two insulating portions enables the electrochemical machining to be restricted to the zone of the edge to be broken. In this way, the zones of the metal part that are not situated facing the conductive zone are not subjected to electrochemical machining as a result of the presence of the first and second portions of insulating material.

Finally, the insulating second portion enables the electrode to be optimally positioned in the vicinity of the zone to be machined.

According to another characteristic of the invention, the conductive zone of the electrode has a concave curved section.

According to yet another characteristic of the invention, the insulating first portion is annular in shape.

In a first possible embodiment of the invention, the conductive zone of the electrode has a concave curved annular shape and extends between the insulating extra thickness and the insulating second portion of cylindrical shape.

This type of electrode is particularly well adapted to machining the edge formed at the opening of an orifice, the cylindrical insulating second portion is designed to be inserted in the orifice so as to center the electrode relative to the orifice and ensure that the annular conductive zone is properly positioned facing the edge to be broken.

In another possible embodiment of the invention, the electrode has two concave curved zones extending in rectilinear and mutually parallel manner, the concave sides of the curved zones facing in opposite directions along a common axis.

This type of electrode is particularly well adapted to machining rectilinear edges formed at the outlet of a groove, such as for example a groove or slot formed in the periphery of a disk in a turbomachine.

Advantageously, each conductive zone of the electrode is formed at the junction between the insulating first portion and a dovetailed flank of the insulating second portion. This dovetailed shape enables the electrode to be properly guided in the slot of a disk while the electrode is being moved along the slot.

The invention also provides an installation for breaking an edge on a metal part, the installation being characterized in that it comprises:
a vessel for receiving the part and designed to be filled with an electrolytic solution so as to immerse at least the edge that is to be machined; and
support and positioning means for supporting the electrode as described above and for positioning the conductive zone of the electrode in immersion facing the edge to be broken and at a determined distance from the edge, so as to break the edge by electrochemical machining.

Instead of being performed manually, the edge breaking of the invention is performed by electrochemical machining using dedicated support and positioning means that make it possible to guarantee that the conductive zone of the electrode is positioned facing the edge to be broken. This makes it possible to perform edge breaking independently of the skill of the operator and in a manner that is reproducible. Furthermore, the risks of collateral damage are eliminated.

According to another characteristic of the invention, the support and positioning means comprise a gantry movable in three mutually perpendicular directions relative to the vessel, thus enabling the electrode to be moved along all three axes in three-dimensional space and enabling the conductive zone to be positioned accurately facing the edge to be broken.

In a preferred embodiment of the invention, the gantry also has non-destructive testing means for inspecting the edge broken on the part, so as to perform testing immediately after the electrochemical machining stage, thus enabling the overall time required for edge breaking to be greatly reduced. By way of example, these non-destructive testing means may be optical testing means or ultrasound testing means.

When the testing means are optical, they comprise a generator emitting a laser beam directly towards the machined zone of the part and a camera for imaging the machined zone, the camera being connected to information processor means for interpreting images taken by the camera. This interpretation of the images consists essentially in determining the value of the radius of curvature of the machined zone in order to deduce therefrom whether the edge breaking operation has been performed correctly.

In a practical embodiment of the invention, the conductive zone of the electrode is made of graphite and the insulating portions of the electrode are made of polymer resin. The conductive zone of the electrode is fed with direct current (DC) at a current density lying in the range 10 amps per square centimeter (A/cm²) to 100 A/cm², and preferably in the range 50 A/cm² to 60 A/cm².

Advantageously, the part is mounted on a support that is movable vertically, e.g. by means of cylinders, relative to the vessel containing the electrolytic solution, in order to move the machined zone out from the electrolytic solution when it is desired to inspect said zone optically.

The invention can be better understood and other details, advantages, and characteristics of the invention appear on reading the following description made by way of non-limiting example and with reference to the accompanying drawings, in which:

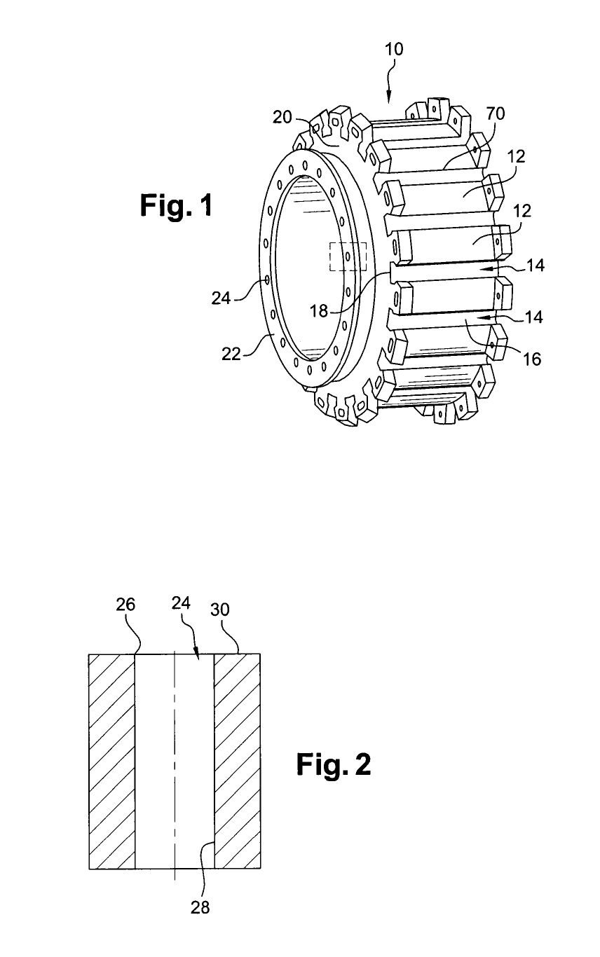

FIG. 1 is a diagrammatic perspective view of a rotor disk in a turbomachine;

FIG. 2 is a diagrammatic representation in section of an orifice in a flange of the FIG. 1 disk;

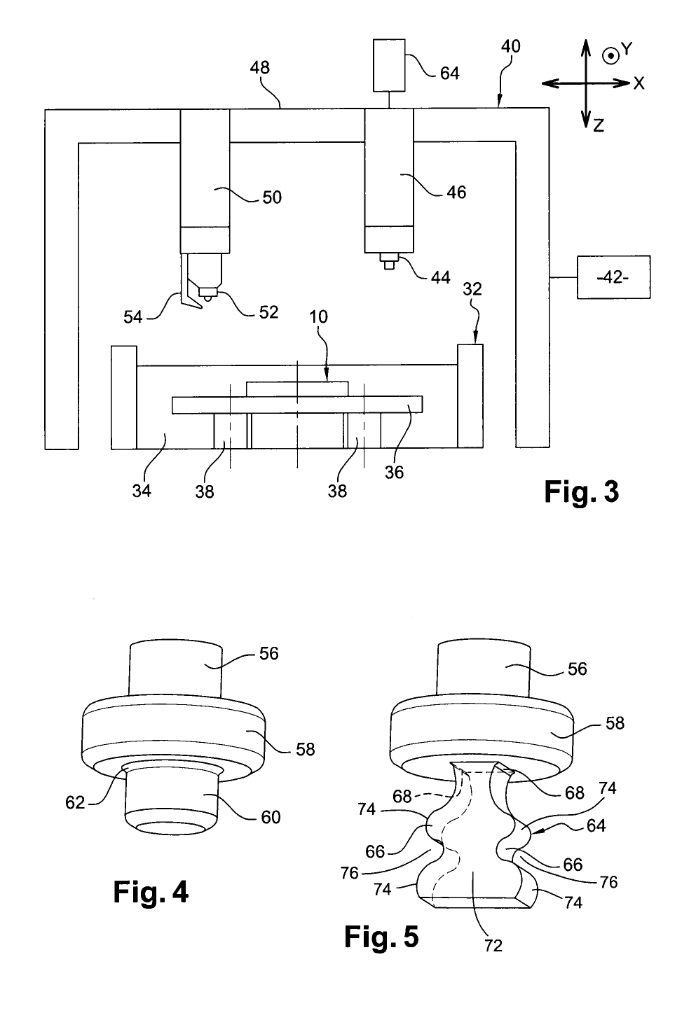

FIG. 3 shows an installation of the invention; and

FIGS. 4 and 5 are diagrammatic perspective view of two electrodes suitable for use in the installation of the invention.

Reference is made initially to FIG. 1, which shows a rotor disk 10 in a turbomachine, having at its outer periphery splines 12 that alternate with slots 14 that are to receive blade roots of the dovetail type.

The bottom surface 16 of each slot 14 thus forms right-angled edges 18 with the upstream face 20 and the downstream face of the disk 10. When forming the slots 12 in the disk 10, burrs are formed on the above-mentioned edges. These edges or corners 18 need to be machined in order to eliminate the burrs and avoid any risk of injury when an operator handles the disk 10.

The rotor disk also has a flange 22 that is provided with a plurality of orifices 24 that are regularly distributed around the axis of the disk and that enable the disk 10 to be fastened to an auxiliary structure. Each end of the orifice 24 has an edge 26 formed at the intersection between the inside surface 28 of the orifice 24 and the surface 30 into which the orifice 24 opens out (FIG. 2).

In conventional manner, the edges formed by these edges are broken manually by operators, which means that it is not possible to obtain a machined surface that is uniform and regular, and which leads to the drawbacks described above.

The invention provides a solution to those problems, and also to those mentioned above, by breaking an edge by electrochemical machining using the installation described with reference to FIG. 3.

This installation comprises a vessel 32 filled with an electrolytic solution 34 within which a support 36 is placed and on which the disk 10 is mounted so that the orifices 24 are substantially vertical or in alignment with a perpendicular to the bottom of the vessel. The support is movable by means of cylinders 38 enabling the disk 10 to be extracted from the electrolytic solution 34 in which it is immersed.

The installation also has positioning and support means for an electrochemical machining electrode, which means are formed by a gantry 40 arranged over the vessel 32. The gantry 40 is movable in three mutually perpendicular directions X, Y, and Z, and its movement is controlled by control means 42. An electrochemical machining electrode 44 is carried by a first support 46 that is secured to a cross-bar 48 of the gantry 40 and that extends towards the vessel 32.

The gantry 40 also has a second support 50 that extends towards the vessel 32 and that carries optical testing means 52 comprising a laser generator and an imaging camera connected to computer processor means. The second support 50 also has a duct 54 for delivering air under pressure.

As shown in FIGS. 4 and 5, the machining electrode 44 has a threaded first portion 56 for screwing into a corresponding threaded portion of the first support 46. The electrode 44 has an insulating annular extra thickness 58 separating the threaded portion 56 from a second insulating portion 60, 64.

In a first embodiment of the electrode of the invention, the electrode has a conductive zone 62 of concave annular shape formed at the junction between the annular extra thickness 58 and the insulating second portion 60 that is cylindrical in shape (FIG. 4).

The electrode is connected to a DC source 64 (FIG. 3).

The machining and the optical testing are performed as follows: the electrode is brought up to the disk in such a manner that the conductive zone 62 is positioned facing the edge 26 that is to be machined, the cylindrical second portion 60 being inserted in the orifice 24 in order to center the electrode 44 relative to the orifice 24 so as to ensure that the conductive zone 62 is positioned at a predetermined circumferentially-constant distance from the edge 26. Thereafter, electricity is applied to the conductive zone 62 in order to perform the breaking. The electrode 44 is moved away from the machined zone and the cylinders 38 move the part 10 vertically so that the machined zone emerges. In another step, the second support 50 is brought up to the machined zone and a stream of air under pressure is applied to the machined zone so as to eliminate all impurities or remaining drops of the electrolytic solution. A laser beam is directed towards the machined zone of the part 10 and the camera takes several images of the zone. The information processor means then interpret the images in order to evaluate the radius of curvature of the machined zone and verify whether the breaking of the edge is correct.

In another embodiment shown in FIG. 5, the insulating second portion 64 has two dovetailed flanks 66 similar to those of the blade root that is to be mounted in a slot 14 of the turbomachine disk 10. The dovetailed flanks 66 are connected to each other by parallel plane walls 72 of the electrode 44 and they are symmetrical to each other about a midplane perpendicular to the plane walls. Each dovetailed flank 66 has two solid portions 74 and a hollow portion 76 arranged between the two solid portions 74. The solid portions 74 and the hollow portion 76 are designed for co-operating respectively with corresponding hollow portions and a solid portion of a slot of the disk 10.

The electrode has two concave curved conductive zones 68 extending rectilinearly and parallel with each other. These two conductive zones are formed at a junction between the annular extra thickness and the dovetailed flanks 66.

The shape of the insulating second portion 64 of the electrode 44 and the shapes of the conductive zones 68 enable the edge formed at the edge 70 connecting a spline 12 with a contiguous slot 14 to be machined. This type of edge is machined by moving the electrode along the slot of the disk, and the insulating second portion 64 ensures that the electrode 44 is properly positioned in the slot 14 of the disk 10.

In a practical embodiment of the invention, the conductive zone(s) 62, 68 of the electrode 44 are made of graphite and the insulating portions 60, 64 of the electrode 44 are made of polymer resin. The electrolytic solution 34 is constituted, for example, by a solution of sodium chloride or of sodium nitrate.

The conductive zone(s) 62, 68 of the electrode 44 are fed with DC at a current density lying in the range 10 A/cm² to 100 A/cm², and preferably in the range 50 A/cm² to 60 A/cm².

The installation of the invention makes it possible to reduce significantly the time needed for the machining stage and for the optical testing stage. In the prior art, the machining and optical testing stages on a turbomachine disk having 70 holes take about 2 hours, whereas with the installation of the invention this time is about ten minutes.

The invention also provides non-destruction testing means other than optical testing means, such as, for example: means for inspecting the edge break zone by ultrasound. Under such circumstances, the support 52 is adapted to receive at least one ultrasound transducer connected to a pulse generator and to information processor means.

1-14. (canceled)

15. An electrode for breaking an edge of a metal part by electrochemical machining, the electrode comprising:
at least one conductive zone configured to be arranged facing an edge of the part that is to be broken;
the conductive zone is of a shape that is complementary to a shape of the broken edge to be produced and is arranged between a first portion forming an insulating extra thickness and an insulating second portion for positioning the conductive zone so that the conductive zone faces the edge to be broken.

16. An electrode according to claim 15, wherein the conductive zone of the electrode has a concave curved section.

17. An electrode according to claim 15, wherein the insulating first portion is annular in shape.

18. An electrode according to claim 15, wherein the conductive zone of the electrode has a concave curved annular shape and extends between the insulating extra thickness and the insulating second portion that is of cylindrical shape.

19. An electrode according to claim 15, comprising two concave curved zones extending in rectilinear and mutually parallel manner, concave sides of the curved zones facing in opposite directions along a common axis.

20. An electrode according to claim 19, wherein each conductive zone is formed at a junction between the insulating first portion and a dovetailed flank of the insulating second portion.

21. An installation for breaking an edge on a metal part, the installation comprising:
a vessel for receiving a part and configured to be filled with an electrolytic solution so as to immerse at least an edge that is to be machined; and
support and positioning means for supporting the electrode according to claim 15 and for positioning the conductive zone of the electrode in immersion facing the edge to be broken and at a determined distance from the edge, so as to break the edge by electrochemical machining.

22. An installation according to claim 21, wherein the support and positioning means comprises a gantry movable in three mutually perpendicular directions relative to the vessel.

23. An installation according to claim 21, wherein the gantry includes non-destructive testing means for inspecting the edge broken on the part.

24. An installation according to claim 23, wherein the non-destructive testing means comprises optical testing means comprising a generator emitting a laser beam directly towards the machined zone of the part and a camera for imaging the machined zone, the camera being connected to information processor means for interpreting images taken by the camera.

25. An installation according to claim 21, wherein the conductive zone of the electrode is made of graphite.

26. An installation according to claim 21, wherein the insulating portions of the electrode are made of polymer resin.

27. An installation according to claim 21, wherein the conductive zone of the electrode is fed with direct current at a current density in a range 10 A/cm² to 100 A/cm², or in a range 50 A/cm² to 60 A/cm².

28. An installation according to claim 21, wherein the part is mounted on a support that is movable vertically, or is movable vertically by cylinders, relative to the vessel containing the electrolytic solution.
